(19) United States
(12) Patent Application Publication
(10) Pub. No.: US 2007/0238470 A1
(43) Pub. Date: Oct. 11, 2007

(54) Conservation of temporary roaming numbers

(75) Inventors: Roger B. Griffith, Dundee, IL (US); Drake W. Barry, Fox River Grove, IL (US); Mark C. Hampson, Carpentersville, IL (US); Thomas J. Parkins, Schaumburg, IL (US); George V. Rykowski, Crystal Lake, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/401,182

(22) Filed: Apr. 10, 2006

(51) Int. Cl. H04Q 7/20

(52) U.S. Cl. 455/455

(57) ABSTRACT

A method for routing mobile station terminated calls. The method can include determining whether a mobile station (110, 110′) is within its home serving area (170) when a call (180) has been placed to the mobile station over a communications network (102). Responsive to determining that the mobile station is in its home serving area, the call can be routed to the mobile station without assigning a temporary roaming number (150) to the call.

### BACKGROUND OF THE INVENTION

1. Field of the Invention

The present invention generally relates to mobile communications and, more particularly, to allocation of temporary roaming numbers.

2. Background of the Invention

Global System for Mobile Communications (GSM) is a mobile communications standard implemented throughout much of the world. GSM implements a signaling system #7 (SS7) signaling network and defines temporary routing numbers, known in GSM as mobile station roaming numbers (MSRNs), that are used by the SS7 signaling network to route a mobile terminated call to the subscriber. In a GSM network, MSRNs typically are stored at mobile switching centers (MSCs). An operator of a GSM network is charged money for each MSRN used in the GSM network. The mobile switching centers therefore are engineered with a finite number of MSRNs.

In GSM, a MSRN is allocated for each call placed to a mobile station (i.e. mobile terminated call) for the purpose of routing the call to the MSC that is currently serving such mobile station. Upon successful delivery of the call, the MSRN that was allocated can be returned to the MSC from which it was allocated for subsequent reuse. If the mobile terminated call cannot be delivered to the serving MSC, the MSRN that was allocated is typically recovered via a MSRN audit procedure. The MSRN audit procedure process may take up to ninety seconds to complete, however.

Since a MSRN is allocated for each mobile terminated call, the pool of available MSRNs at a particular MSC can be depleted during periods of high call activity. When the MSRNs are depleted, all mobile terminated call attempts to subscribers of the MSC fail until a MSRN is returned to the pool of available MSRNs. Such failed call attempts are undesirable, especially in times of emergency.

### SUMMARY OF THE INVENTION

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention;

FIG. 2 depicts a message flow diagram for establishing a call to a mobile station;

FIG. 3 depicts another message flow diagram for establishing a call to a mobile station; and

FIG. 4 depicts a flowchart presenting a communication method that is useful for understanding the present invention.

### DETAILED DESCRIPTION

The present invention relates to a method for routing mobile station terminated calls. In response to receiving a call to a mobile station, a mobile location request can be sent to a visitor location register (VLR). A first acknowledgement can be received from the VLR in response to the mobile location request. The first acknowledgement can indicate whether the mobile station is in the home serving area. If the first acknowledgement indicates that the mobile station is in its home serving area, the call can be routed to the mobile station without assigning a temporary roaming number (TRN) to the call.

The present invention also relates to a method for routing mobile station terminated calls that includes determining whether a mobile station is within its home serving area in response to receiving a call to the mobile station over a Global System for Mobile Communications (GSM) network. Responsive to determining that the mobile station is in its home serving area, the call can be routed to the mobile station without assigning a temporary roaming number (TRN) to the mobile terminated call.

Another embodiment of the present invention can include a machine readable storage being programmed to cause a machine to perform the various steps described herein.

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The inventive arrangements disclosed herein relate to a method and a system that dedicates temporary routing numbers (TRNs) exclusively to mobile terminated calls (hereinafter “calls”) that are placed to mobile stations which are not currently in their home serving area. Instead of assigning a TRN to a call that is placed to a mobile station that is in its home serving area, the home serving area's mobile switching center (MSC) is tasked with routing the call without using a TRN. Accordingly, for a given level of call traffic, the total number of TRNs that are allocated by MSCs in a communication system can be significantly reduced, thereby reducing the risk of depleting available TRNs.

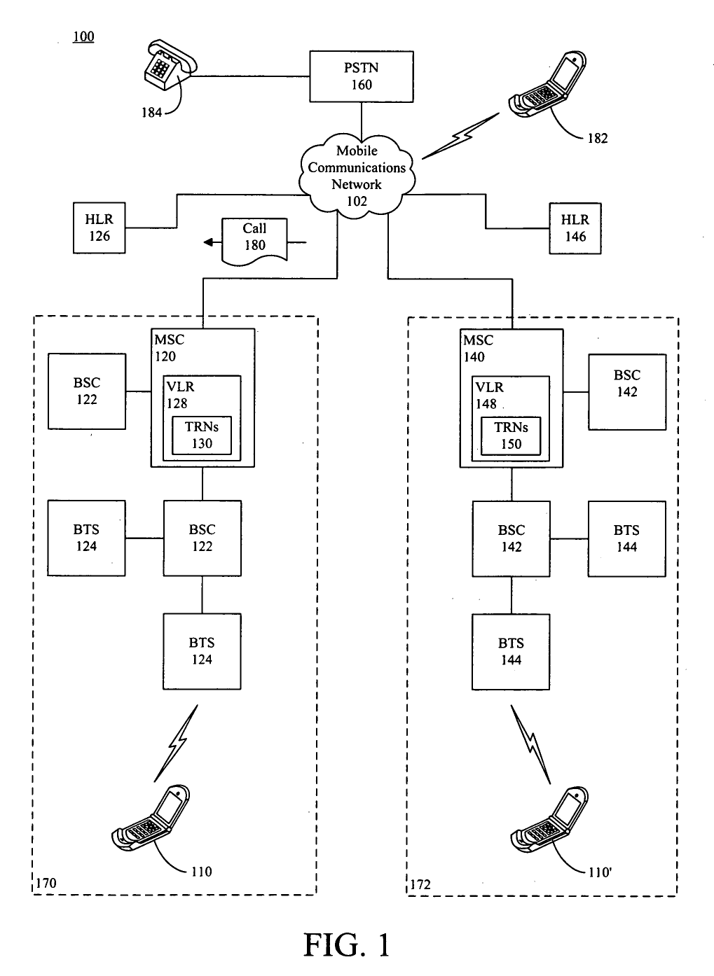

FIG. 1 depicts a communication system 100 that is useful for understanding the present invention. In one arrangement, the communication system 100 can include a mobile communications network 102. One example of such a communications network is a Global System for Mobile Communications (GSM) network. GSM typically implements time division multiple access (TDMA) modulation. However, the invention is not limited in this regard. For example, the communications network 102 also can implement frequency division multiple access (FDMA), code division multiple access (CDMA), wideband code division multiple access (WCDMA), orthogonal frequency division multiple access (OFDMA), or any other suitable modulation format.

To support wireless communications with one or more mobile stations 110, 110′, the communication system 100 can include a plurality of MSCs 120, 140. The MSC 120 can be communicatively linked to one or more base transceiver stations (BTSs) 124 via one or more base station controllers (BSCs) 122. Similarly, the MSC 140 can be communicatively linked to one or more BTSs 144 via one or more BSCs 142. In addition, the MSC 120 can be communicatively linked to the MSC 140, via the mobile communications network 102, via a public switched telephone network 160, or via any other suitable communications network. The communication system 100 also can include repeaters (not shown), access points (not shown), and other network infrastructure components.

The communication system 100 can include one or more home location registers (HLRs) 126, 146. Each HLR 126, 146 can be accessed by one or more MSCs and can comprise a database of subscriber information which is accessible by the MSCs. For example, the HLR 126 can be accessed by the MSC 120 and contain subscriber information accessible by the MSC 120. Similarly, the HLR 126 can be accessed by the MSC 140 and contain subscriber information accessible by the MSC 140. Alternatively, the HLR 146 can be accessed by the MSC 140 and the MSC 140 can access subscriber information from the HLR 146.

Assuming that the home serving area 170 for the mobile stations 110, 110′ is the area served by the MSC 120, subscriber information for the mobile stations 110, 110′ can be contained in the HLR 126. In addition, the HLR 126 can provide details of the present location of the mobile stations 110, 110′. For example, if the mobile station 110′ is activated in the serving area 172 serviced by the MSC 140 (i.e. roaming in the serving area), the MSC 140 can forward a location update to the HLR 126 that notifies the HLR 126 that the mobile station 110′ is in the serving area 172. The HLR 126 can store such information in its database.

Each of the MSCs 120, 140 also can be communicatively linked to a respective visitor location register (VLR) 128, 148. The VLR 128 can cache a subset of the information contained in the HLRs 126, 146 that pertains to mobiles stations that are currently under the jurisdiction of the MSC 120, for instance mobile station 110. For example, information pertaining to the mobile station 110 can be transferred from the HLR 126 to the VLR 128 when the mobile station 110 is activated in the serving area 170. Similarly, the VLR 148 can cache a subset of the information that pertains to mobile stations that are currently under the jurisdiction of the MSC 140. For instance, information pertaining to the mobile station 110′ can be transferred from the HLR 126 to the VLR 148 when the mobile station 110′ is activated in the serving area 172.

The MSC 120 and MSC 140 each can store a respective pool of temporary roaming numbers (TRNs) 130, 150. The TRNs 130, 150 can be used by a signaling network, for example a signaling system #7 (SS7) signaling network, to route calls to the mobile stations 110, 110′. For example, when a call 180 is placed to the mobile station 110′, a call management service request can be placed to the MSC 120 since the MSC 120 supports the home serving area 170 of the mobile station 110′. The MSC 120 then can send a routing information request to the HLR 126. The HLR 126 can retrieve from its database information that identifies the current location of the mobile station 110′. If the HLR 126 determines that the mobile station 110′ is roaming in a serving area 172, which is not the mobile station's home serving area, the HLR 126 can request a TRN 150 from the VLR 148 and return the TRN 150 to the MSC 120 in a routing information acknowledgment. The pool of available TRNs 150 on the VLR 148 will therefore be depleted by one until the TRN 150 is returned or recovered.

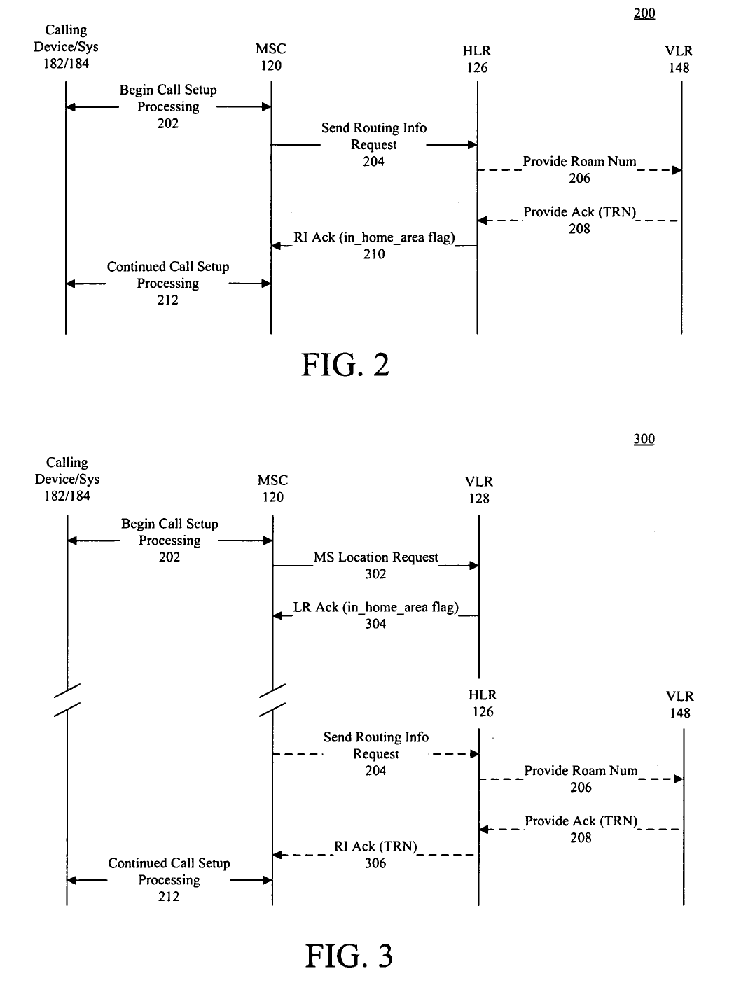

In accordance with the inventive arrangements disclosed herein, TRN depletion can be avoided when a call 180 is placed to a mobile station, such as mobile station 110, that is presently in its home serving area 170. A flow diagram 200 for establishing the call 180 from a communication device, such as a mobile station 182 or a telephone 184, to the mobile station 110 via the mobile communications network 102 is depicted in FIG. 2.

At step 202, call setup processing can begin for establishing a communication link between a communication device and/or system establishing the call 180 and the mobile station 110. Initial steps of call setup processing can occur between such device/system and the MSC 120 and can be implemented in accordance with an applicable protocol. For example, if the call originates from the mobile station 182 in accordance with the GSM protocol, the initial steps of the call setup processing can be implemented in accordance with mobile-to-mobile call setup procedures defined in the GSM protocol. If, however, the call originates from a telephone 184 via a public switched telephone network (PSTN) 160 and the mobile communications network 102 is a GSM network, the initial steps of call setup processing can be implemented in accordance with PSTN-to-mobile call setup procedures defined in the GSM protocol. Still, mobile terminated calls can originate from a myriad of other devices and/or systems, and a variety of known call setup processing procedures between such devices/systems and the MSC 120 may be applicable. Such call setup processing procedures are within the intended scope of the present invention.

At step 204, the MSC 120 can send a routing information request to the HLR 126 requesting routing information for the mobile station 110. The HLR 126 can reference its database to determine the present location of the mobile station 110. If the mobile station is not in its home serving area 170, for example the call 180 has been placed to the mobile station 110′ that is presently located in serving area 172, at step 206 the HLR 126 can send a provide roam number request to the VLR 148 that serves the area 172. Proceeding to step 208, the VLR 148 can respond to the request with a provide roam number acknowledgement that includes a TRN 150 to assign to the call 180.

Continuing to step 210, the HLR 126 can send the TRN 150 to the MSC 120. For example, the TRN 150 can be included in a routing information acknowledgement sent from the HLR 126 to the MSC 120. In addition, a home serving area indicator can be sent to the MSC 120 to indicate that the mobile station 110′ is not in its home serving area. In one arrangement, the home serving area indicator can be a flag that is set in the routing information acknowledgement when the mobile station 110 is in its home serving area. In another arrangement, a specific home area acknowledgment can be sent from the HLR 126 to the MSC 120. Notwithstanding, the invention is not limited in this regard and the indicator can be sent to the MSC 120 in any other suitable manner.

Notably, a TRN 130, 150 need not be assigned to the mobile station 110 if the mobile station 110 is in its home serving area 170. In such circumstance, steps 206 and 208 may be eliminated. Thus, the HLR 126 can respond to the routing request sent in step 204 with a home serving area indicator set to inform the MSC 120 that the mobile station 110 is in the home serving area. As noted, the home serving area indicator can be sent with the routing information acknowledgement sent in step 210, or sent in any other suitable manner.

The home serving area indicator can be processed by the MSC 120 as part of a call routing process. Responsive to receiving the indication from the HLR 126 that the mobile station 110 is in its home serving area 170, the MSC 120 can establish the call 180 with the mobile station 110 without use of a TRN 130, 150. Proceeding to step 212, suitable call setup processing can continue to complete the connection of the call 180 to the mobile station 110.

An alternate message flow diagram 300 for establishing the call 180 to the mobile station 110 via a mobile communications network 102 is depicted in FIG. 3. The call setup process can be substantially similar to the call setup process described for the flow diagram 200 of FIG. 2. However, rather than requesting the HLR 126 to identify the location of the mobile station 110, the MSC 120 can retrieve such information from the VLR 128. The VLR 128 can contain a subset of HLR data and/or state of presence information for each mobile station currently activated in the jurisdiction of the MSC 120. At step 302, for instance, the MSC 120 can send a mobile location request to the VLR 128.

In response to the mobile location request, at step 304 the VLR 128 can send a location request acknowledgement to the MSC 120 indicating whether the mobile station 110 is in its home serving area 170. The location request acknowledgement also can indicate whether the mobile station 110 is available for accepting the call. Since the VLR 128 contains HLR data for the mobile station 110 when the mobile station 110 is in the serving area 170 served by the MSC 120, the existence of such data in the VLR 128 can indicate that the mobile station 110 is activated in the serving area 170. If the VLR 128 does not contain such data, lack of the data can indicate that the mobile station 110 is not activated within the serving area 170. In another arrangement, the data contained in the VLR 128 can indicate the present location of the mobile station 110, and such data can be accessed to determine whether the mobile station 110 is in its home serving area 170.

The location request acknowledgement sent by the VLR 128 can include an in_home_area flag, although the invention is not limited in this regard and the indicator can be sent to the MSC 120 in any other suitable manner. If the location request acknowledgement indicates that the mobile station 110 is in its home serving area 170, the MSC 120 can route the call to the mobile station 110 by proceeding to step 212 to complete call setup processing, thereby skipping steps 204-208 and step 306. Accordingly, the MSC 120 can establish the call 180 with the mobile station 110 without use of a TRN 130,150.

Because the VLR 128 can be dedicated exclusively to the MSC 120 and may even be contained within the MSC 120, retrieving the location information from the VLR 128 when the mobile station 110 is in its home serving area 170 can be more efficient than retrieving such information from the HLR 126. Indeed, if the mobile station 110 is presently located in its home serving area 170, the MSC 120 need not send a routing information request to the HLR 126, thereby reducing use of valuable backhaul bandwidth.

If, however, the call 180 is placed to the mobile station 110′ and the VLR 128 does not have cached updated HLR data or current status information for the mobile station 110′, such lack of data can indicate that the mobile station 110′ is not currently activated in the serving area 170. Accordingly, the process can proceed to step 204 and the MSC 120 can send a routing information request to the HLR 126 requesting routing information for the mobile station 110′. Proceeding to step 206 the HLR 126 can send a provide roam number request to the VLR 148 that serves the area 172. At step 208, the VLR 148 can respond to the request by sending a roam number acknowledgement to the HLR 126. The roam number acknowledgement can include a TRN 150 to assign to the call 180. At step 306, the HLR 126 can include the TRN 150 in the routing information acknowledgement that is sent to the MSC 120. In this arrangement, the location request acknowledgement need not contain an in-home-area flag since such flag is contained in the location response acknowledgement sent in step 304.

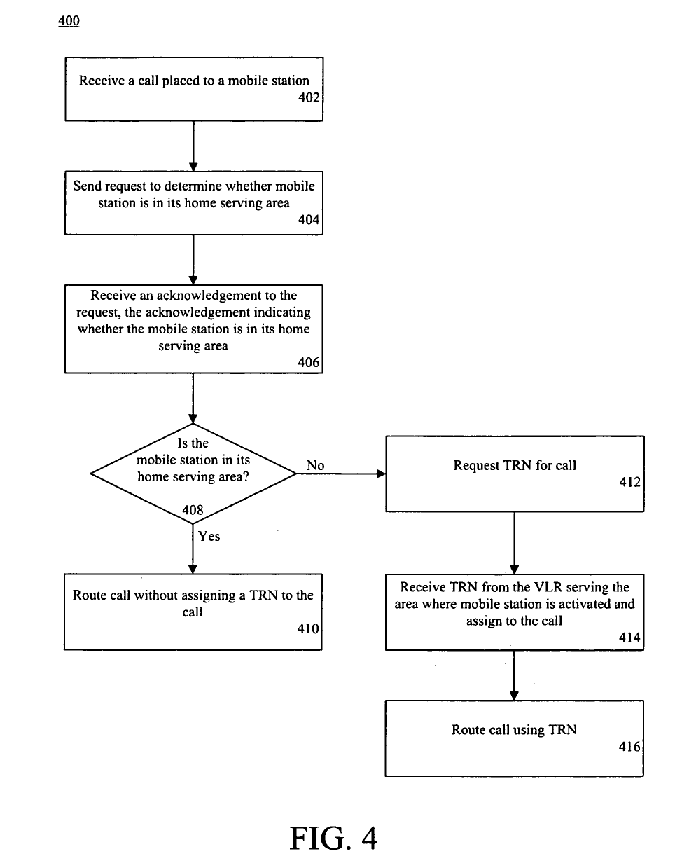

FIG. 4 depicts a flowchart presenting a communication method 400 that is useful for understanding the present invention. At step 402, a call that is placed to a mobile station can be received. At step 404, a request can be sent to determine whether the mobile station is in its home serving area. For example, in one arrangement the request can be sent to an HLR in a sent routing information request. In another arrangement, the request can be sent to a VLR in a mobile station location request. Continuing to step 406, an acknowledgement to the request can be received indicating whether the mobile station is in its home serving area.

Referring to decision box 408 and step 410, if the mobile station is in its home serving area, the call can be routed without assigning a TRN to the call. Referring to step 412, if the mobile station is not in its home serving area, a TRN can be requested for the call. At step 414, the TRN can be received from the VLR serving the area where the mobile station is activated (i.e. roaming area) and assigned to the call. For example, the VLR for the roaming area can forward the TRN to the HLR serving the mobile station's home serving area, and the HLR can include the TRN in a routing information acknowledgement sent the MSC of the home serving area. Proceeding to step 416, the call then can be routed using the TRN.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for routing mobile station terminated calls comprising:
responsive to receiving a call to a mobile station, sending a mobile location request to a visitor location register (VLR);
receiving a first acknowledgement from the VLR in response to the mobile location request, the first acknowledgement indicating whether the mobile station is in the home serving area; and
if the first acknowledgement indicates that the mobile station is in its home serving area, routing the call to the mobile station without assigning a temporary roaming number (TRN) to the call.

2. The method according to claim 1, further comprising allocating a TRN to the call in response to the first acknowledgement indicating that the mobile station is not in its home serving area.

3. The method according to claim 2, wherein allocating the TRN to the call comprises:
sending a routing information request to a home location register (HLR); and
receiving the TRN via the HLR.

4. The method according to claim 3, wherein receiving the TRN comprises receiving the TRN in a second acknowledgement that is sent by the HLR.

5. The method according to claim 4, wherein the second acknowledgement comprises a flag that is set to indicate whether the mobile station is in the home serving area.

6. The method according to claim 5, wherein the second acknowledgement is a routing information acknowledgement.

7. The method according to claim 1, wherein the first acknowledgement is a location request acknowledgement.

8. A method for routing mobile station terminated calls comprising:
responsive to receiving a call to a mobile station over a Global System for Mobile Communications (GSM) network, determining whether the mobile station is within its home serving area; and
responsive to determining that the mobile station is in its home serving area, routing the call to the mobile station without assigning a temporary roaming number (TRN) to the mobile terminated call.

9. The method according to claim 8, wherein determining whether the mobile station is within its home serving area comprises receiving a home serving area indicator that indicates whether the mobile station is in the home serving area.

10. The method according to claim 8, wherein determining whether the mobile station is within its home serving area comprises sending a routing information request to a home location register (HLR).

11. The method according to claim 10, further comprising receiving an acknowledgement from the HLR in response to the routing information request, the acknowledgement indicating whether the mobile station is in the home serving area.

12. The method according to claim 10, further comprising receiving a routing information request acknowledgement from the HLR in response to the routing information request, the routing information request acknowledgement indicating whether the mobile station is in the home serving area.

13. The method according to claim 8 wherein determining whether the mobile station is within its home serving area comprises:
sending a mobile location request to a visitor location register (VLR); and
receiving an acknowledgement from the VLR in response to the mobile location request, the acknowledgement indicating whether the mobile station is in the home serving area.

14. The method according to claim 8, further comprising allocating a TRN to the call in response to determining that the mobile station is not in its home serving area.

15. The method according to claim 14, wherein allocating the TRN to the call comprises receiving the TRN from a mobile switching center (MSC) serving an area in which the mobile station is presently roaming.

16. A machine readable storage having stored thereon a computer program having a plurality of code sections comprising:
code for sending a mobile location request to a visitor location register (VLR) in response to receiving a call to a mobile station;
code for receiving a first acknowledgement from the VLR in response to the mobile location request, the first acknowledgement indicating whether the mobile station is in the home serving area; and
code for routing the call to the mobile station without assigning a temporary roaming number (TRN) to the call if the first acknowledgement indicates that the mobile station is in its home serving area.

17. The machine readable storage of claim 16, further comprising code for allocating a TRN to the call in response to the first acknowledgement indicating that the mobile station is not in its home serving area.

18. The machine readable storage of claim 17, further comprising:
code for sending a routing information request to a home location register (HLR); and
code for receiving the TRN via the HLR.

19. The machine readable storage of claim 18, wherein the code for receiving the TRN comprises code for receiving the TRN in a second acknowledgement that is sent by the HLR.

20. The machine readable storage of claim 19, wherein the second acknowledgement comprises a flag that is set to indicate whether the mobile station is in the home serving area.
